(19) United States
(12) Patent Application Publication
(10) Pub. No.: US 2026/0085187 A1
(43) Pub. Date: Mar. 26, 2026

(54) SILICONE RESIN COMPOSITION, THERMALLY CONDUCTIVE SHEET, AND ORGANOPOLYSILOXANE

(71) Applicant: JNC CORPORATION, Tokyo (JP)

(72) Inventors: Yuuto KANNO, Chiba (JP); Misa KOSUGI, Chiba (JP); Shugo TANAKA, Chiba (JP)

(73) Assignee: JNC CORPORATION, Tokyo (JP)

(21) Appl. No.: 19/109,545

(22) PCT Filed: Jul. 21, 2023
(86) PCT No.: PCT/JP2023/026718

§ 371 Date: Mar. 6, 2025

(30) Foreign Application Priority Data
Oct. 28, 2022 (JP) 2022-173740

(51) Int. Cl. C08L 83/14; C08G 77/08; C08J 5/18; C08K 3/22; C08K 5/549; C08K 7/18

(52) U.S. Cl. CPC C08L 83/14; C08G 77/08; C08J 5/18; C08K 3/22; C08K 7/18; C08J 2383/04; C08K 2003/2227; C08K 5/549; C08K 2201/001; C08K 2201/005

(57) ABSTRACT

Provided is a silicone resin composition that retains flowability even at high levels of filling with a thermally conductive filler, and that provides suppression of oil bleed during use. This silicone resin composition comprises: as a component (A), an organopolysiloxane that is represented by formula (1) and has a molecular weight distribution (Mw/Mn) of not more than 1.30; and, as a component (B), a thermally conductive filler.

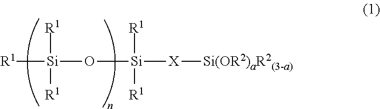

(In Formula (1), each R¹ independently represents a monovalent saturated hydrocarbon group or a monovalent aromatic hydrocarbon group, each R² independently represents a monovalent saturated hydrocarbon group, X represents oxygen or a divalent hydrocarbon group, n is an integer equal to or greater than 1, and a is an integer from 1 to 3.)

### TECHNICAL FIELD

The invention relates to a silicone resin composition.

### RELATED ART

Many electronic components generate heat during use, and it is necessary to remove the heat while maintaining the functions. In particular, in recent electronic components, the heat generation amount has increased due to a higher level of integration and a higher output of the circuit board. Therefore, the importance of heat management increases.

As a means of removing heat from electronic components, a method has been proposed to release heat from electronic products by interposing a thermally conductive material such as a thermally conductive grease or sheet between the electronic components and cooling members such as heat sinks. As one of such thermally conductive materials, silicone resin compositions consisting of organopolysiloxane and a thermally conductive fillers such as aluminum oxide powder and zinc oxide powder are used (see Patent Document 1, 2, or 3).

For the thermally conductive material, Bruggeman's model is known as an equation for predicting thermal conductivity. The equation indicates that when the filling rate of the thermally conductive filler is low, the thermal conductivity hardly changes regardless of the filling rate, while the thermal conductivity increases rapidly at a filling rate above a certain level. In other words, to increase the thermal conductivity, it is important to fill as much thermally conductive filler as possible.

Meanwhile, as the filling rate of the thermally conductive filler increases, the fluidity of the resin composition used in the thermally conductive material significantly decreases. This not only makes it difficult to discharge and apply the resin composition, but also prevents the resin composition from conforming to fine irregularities on the surface of the electronic component and heat sinks, resulting in increased contact thermal resistance. As a method to solve this problem, a method of using an additive to improve the dispersibility of the thermally conductive fillers in the resin composition is known (see Patent Document 4).

However, the additive can become detached from the resin composition during use, causing oil bleed. When oil bleed occurs, it may lead to poor conductivity due to contact failure or contamination of electronic components.

### CITATION LIST

### Patent Literature

Patent Document 1: Japanese Laid-open No. 2005-054099
Patent Document 2: Japanese Laid-open No. 2004-091743
Patent Document 3: Japanese Laid-open No. 2000-063873
Patent Document 4: Japanese Laid-open No. 2022-075003

### SUMMARY OF INVENTION

### Technical Problem

An objective of the invention is to provide a silicone resin composition that maintains flowability even in a state where a thermally conductive filler is at a high level of filling, and not only has good workability, but also inhibits oil bleed.

### Solution to Problem

The inventors have devoted efforts to solve the issue, and found that a silicone resin composition as follows has a specific structure and and is useful: the silicone resin composition has an organopolysiloxane having a molecular weight distribution (Mw/Mn) of not more than 1.30; and a thermally conductive filler. Accordingly, the invention is completed.

That is, according to the invention, a silicone resin composition as follows is provided:
Item 1. A silicone resin composition includes: as a component (A), an organopolysiloxane that is represented by Formula (1) and has a molecular weight distribution (Mw/Mn) of not more than 1.30,

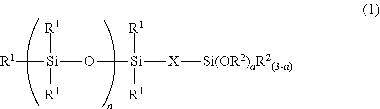

(In Formula (1), each R¹ independently represents a monovalent saturated hydrocarbon group or a monovalent aromatic hydrocarbon group, each R² independently represents a monovalent saturated hydrocarbon group, X represents oxygen or a divalent hydrocarbon group, n is an integer equal to or greater than 1, and a is an integer from 1 to 3.)
and
a thermally conductive filler, as a component (B).
Item 2. The silicone resin composition according to Item 1, further includes, as a component (C), an organopolysiloxane other than the component (A).
Item 3. The silicone resin composition according to Item 1 or 2 further includes: as a component (D), a cross-linking agent.
Item 4. In the silicone resin composition according to any one of Items 1 to 3, a content of the component (B) is 50 vol % or more based on a volume of the silicone resin composition.
Item 5. A thermally conductive sheet is formed by curing the silicone resin composition according to Item 3 or 4.
Item 6. An organopolysiloxane represented by Formula (1) and has a molecular weight distribution (Mw/Mn) of not more than 1.30.

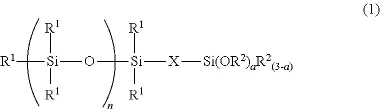

(In Formula (1), each R¹ independently represents a monovalent saturated hydrocarbon group or a monovalent aromatic hydrocarbon group, each R² independently represents a monovalent saturated hydrocarbon group. X represents oxygen or a divalent hydrocarbon group, n is an integer equal to or greater than 1, and a is an integer from 1 to 3.)

### Effects of Invention

In the silicone resin composition of the invention, the flowability is maintained even in the case where the thermally conductive filler is at a high level of filling. Therefore, the operability is high. In addition, oil bleed can be suppressed, and poor conductivity due to contact failure or contamination of electronic components can be prevented.

### BRIEF DESCRIPTION OF DRAWINGS

FIG. 1 is a conceptual diagram of an oil bleed evaluation test.

### DESCRIPTION OF EMBODIMENTS

The following describes the embodiments of the invention, but the invention is not limited to the following embodiments.

### [Component (A)]

Component (A) is an organopolysiloxane represented by Formula (1) and having an alkoxysilyl group at a terminal and a vinyl group at an other terminal.

(In Formula (1), each R¹ independently represents a monovalent saturated hydrocarbon group or a monovalent aromatic hydrocarbon group, each R² independently represents a monovalent saturated hydrocarbon group, X represents oxygen or a divalent hydrocarbon group, n is an integer equal to or greater than 1, and a is an integer from 1 to 3.)

As the monovalent saturated hydrocarbon group, examples may include a linear alkyl group, a branched alkyl group, a cyclic alkyl group. As the linear alkyl group, examples may include a methyl group, an ethyl group, a propyl group, and a n-butyl group. As the branched alkyl group, examples may include an isopropyl group, an isobutyl group, a tert-butyl group, and a 2-ethylhexyl group. As the cyclic alkyl group, examples may include a cyclopentyl group, a cyclohexyl group, and a 4-methylcyclohexyl group. As the monovalent aromatic hydrocarbon group, examples may include a phenyl group and a tolyl group.

As the alkoxysilyl group, examples may include trimethoxysilyl, triethoxysilyl, tripropoxysilyl, methyldimethoxysilyl, methyldiethoxysilyl, ethyldimethoxysilyl, ethyldiethoxysilyl, propyldimethoxysilyl, propyldiethoxysilyl, dimethylmethoxysilyl, dimethylethoxysilyl, diethylmethoxysilyl, diethylethoxysilyl, dipropylmethoxysilyl, dipropylethoxysilyl, methylethylmethoxysilyl, methylpropylmethoxysilyl, ethylpropylmethoxysilyl, methylethylethoxysilyl, methylpropylethoxysilyl, ethylpropylethoxysilyl. Among the above, trimethoxysilyl is preferred from the viewpoints of affinity with the thermally conductive filler, ease of obtaining raw materials for manufacturing, etc.

In the case where the ratio of the weight average molecular weight (Mw) to the number average molecular weight (Mn) of the component (A) in terms of polystyrene, as measured by gel permeation chromatography (GPC), is defined as the molecular weight distribution (Mw/Mn), it is necessary that Mw/Mn is 1.30 or less. When the molecular weight distribution (Mw/Mn) is within this range, the content ratio of high molecular weight and low molecular weight components that inhibit dispersion becomes small, and a silicone resin composition with excellent flowability can be obtained.

### [Component (B)]

The component (B) serves as a thermally conductive filler in the silicone resin composition of the invention. The component (B) can be used alone or in combination of two or more types.

As specific examples of the component (B), examples may include aluminum oxide, aluminum nitride, boron nitride, zinc oxide, diamond, graphene, graphite, carbon nanotubes, carbon fibers, glass fibers, or a combination of two or more of thereof. For the filler of the component (B), there are no particular limitations on the crystal form, particle size, surface condition, and presence or absence of surface treatment, etc.

From the viewpoint of heat dissipation, the content of the component (B) is preferably 30 volume % or more, and more preferably 50 volume % or more, based on the volume of the silicone resin composition. The silicone resin composition of the invention has good heat dissipation properties while maintaining flowability.

### Component (C)

The silicone resin composition of the invention can further include an organopolysiloxane other than the component (A) as the component (C). The component (C) can be appropriately used for the purpose such as viscosity adjustment and imparting curability to the silicone resin composition of the invention, but the invention is not limited thereto. The component (C) can be used alone or in combination of two or more types.

As specific examples of the component (C), examples may include dimethylpolysiloxane, methylphenylpolysiloxane, amino-modified polysiloxane, epoxy-modified polysiloxane, carboxy-modified polysiloxane, carbinol-modified polysiloxane, polyether-modified polysiloxane, alkyl-modified polysiloxane, fluorine-modified polysiloxane, alkenyl-modified polysiloxane, silanol-modified polysiloxane, alkoxysilyl-modified polysiloxane, or combinations of two or more of the above.

The silicone resin composition of the invention can be cured by crosslinking through the addition of a crosslinking agent as a component (D). Polysiloxane other than the component (C) may be added as the crosslinking agent.

The curing mechanism is not particularly limited, and examples include hydrosilylation reaction, condensation reaction, and free radical reaction by organic peroxide. Among the above, the curing mechanism is preferably the hydrosilylation reaction, considering rapid curing and absence of by-products. The component (C) and the component (D) can be appropriately selected according to the curing mechanism.

In the case of using the hydrosilylation reaction as the curing mechanism, for example, an alkenyl-modified polysiloxane having an average of two or more alkenyl bonds in one molecule can be used as the component (C), and a silicon compound having an average of two or more silicon-hydrogen bonds in one molecule and a platinum-based catalyst can be used as the component (D).

Specific examples of the silicon compound having an average of two or more silicon-hydrogen bonds in one molecule include oligosiloxane such as tris(dimethylsiloxy)methylsilane, tetrakis(dimethylsiloxy)silane, 1,3,5,7-tetramethylcyclotetrasiloxane, and polysiloxane having a silicon-hydrogen bond at the molecular chain terminal or a side chain.

Specific examples of the platinum-based catalyst may include chloroplatinic acid, an alcohol solution of chloroplatinic acid, a platinum olefin complex, a platinum alkenylsiloxane complex, and a platinum carbonyl complex.

As the addition amount of the platinum-based catalyst, the amount can be any amount necessary for curing. However, to sufficiently cure the composition, the addition amount is preferable to be 0.01 ppm or more in terms of platinum element with respect to the total amount of the composition. To ensure storage stability of the composition, it is preferable to be 10 ppm or less in terms of platinum element with respect to the total amount of the composition.

In the case of using the condensation reaction as the curing mechanism, for example, organopolysiloxane having at least two silanol groups or silicon atom-bonded hydrolyzable groups in one molecule can be used as the component (C), and a silane having at least three silicon atom-bonded hydrolyzable groups in one molecule or a hydrolysate thereof and/or a catalyst for condensation reaction can be used as the component (D).

Specific examples of the silicon atom-bonded hydrolyzable group include an alkoxy group such as a methoxy group, an ethoxy group, a propoxy group; an alkenoxy group such as a vinyloxy group, a propenoxy group, an isopropenoxy group, an 1-ethyl-2-methylvinyloxy group; an alkoxyalkoxy group such as a methoxyethoxy group, an ethoxyethoxy group, a methoxypropoxy group; an acyloxy group such as an acetoxy group, an octanoyloxy group; a ketoxime group such as a dimethylketoxime group, a methylethylketoxime group; an amino group such as a dimethylamino group, a diethylamino group, a butylamino group; an aminoxy group such as a dimethylaminoxy group, a diethylaminoxy group; and an amide group such as an N-methylacetamide group, an N-ethylacetamide group.

Specific examples of the catalyst for the condensation reaction include an organic titanium ester such as tetrabutyl titanate, tetraisopropyl titanate; an organic titanium chelate compound such as diisopropoxybis(acetylacetate)titanium, diisopropoxybis(ethylacetoacetate)titanium; an organic aluminum compound such as aluminum tris(acetylacetonate), aluminum tris(ethylacetoacetate); an organic zirconium compound such as zirconium tetra(acetylacetonate), zirconium tetrabutylate; organic tin compounds such as dibutyltin dioctanoate, dibutyltin dilaurate, butyltin 2-ethylhexanoate; a metal salt of organic carboxylic acid such as tin naphthenate, tin oleate, tin butyrate, cobalt naphthenate, zinc stearate; an amine compound and the salts thereof, such as hexylamine, dodecylamine phosphate; a quaternary ammonium salt such as benzyltriethylammonium acetate; an alkali metal salt of lower fatty acids such as potassium acetate, lithium nitrate; a dialkylhydroxylamine such as dimethylhydroxylamine, diethylhydroxylamine; and an organosilicon compound containing a guanidyl group.

In the case of using a free radical reaction by using an organic peroxide as the curing mechanism, an organopolysiloxane having at least one alkenyl group in one molecule can be used as the component (C), and an organic peroxide can be used as the component (D).

Specific examples of the organic peroxide include benzoyl peroxide, dicumyl peroxide, 2,5-dimethylbis(2,5-tert-butylperoxy)hexane, di-tert-butyl peroxide, and tert-butyl perbenzoate.

In the silicone resin composition of the invention, it is preferable that the content of the component (A) is 0.1 parts by mass to 50 parts by mass with respect to 100 parts by mass of the component (B), and it is more preferable that the content is 1.0 part by mass to 30 parts by mass. When the content of the component (A) with respect to 100 parts by mass of the component (B) falls within the range, the component (B) can be stably dispersed, and a sufficient filling rate of the component (B) can be secured. Accordingly, sufficient heat dissipation properties can be attained. In the case where the component (C) is included, it is preferable that the total content of the component (A) and the component (C) is 0.1 parts by mass to 50 parts by mass with respect to 100 parts by mass of the component (B), and it is more preferable that the total content is 1.0 parts by mass to 30 parts by mass with respect to 100 parts by mass of the component (B).

The viscosity of the silicone resin composition of the invention at 25° C. is preferably 1000 Pa's or less. When the viscosity falls within the range, the flowability of the composition is good, making it easy to handle such as discharging and applying.

The silicone resin composition of the invention can be used with various additives such as surfactants, plasticizers, defoaming agents, adhesion promoters, and thickeners to the extent of not affecting the purpose of the composition.

In the case where the silicone resin composition of the invention is curable, a curing reaction inhibitor can be added as a component (E) to adjust the curing speed of the composition and improve handling workability.

Specific examples of the curing reaction inhibitor include 1,3,5,7-tetramethyl-1,3,5,7-tetravinylcyclotetrasiloxane, 1-ethynyl-2-cyclohexanol, a phosphine compound, and a mercapto compound.

The thermally conductive sheet can be obtained by curing the silicone resin composition of the invention.

The thermally conductive sheet is used by being interposed between an electronic component and a cooling member inside an electronic device and the like, efficiently conducting heat generated by the electronic component to the cooling member. Specific examples of the electronic component include a CPU, a power amplifier, and a power supply. A specific example of the cooling member includes a heat sink.

The manufacturing method of the thermally conductive sheet is not particularly limited, but it can be manufactured, for example, by adopting a method that includes a step of preparing the silicone resin composition by mixing the components (A), (B), (C), and (D), and a step of molding the silicone resin composition into a sheet shape and curing the composition to obtain a sheet-shaped molded body.

### EXAMPLES

The invention will be described in more detail below. In the examples, “parts” and “%” are based on mass (parts by mass, mass %) unless otherwise specified. Furthermore, the invention is not limited in any way by these examples.

### <Molecular Weight Measurement>

The molecular weight of the organopolysiloxane was measured by gel permeation chromatography (GPC), and the ratio of weight average molecular weight (Mw) to number average molecular weight (Mn) was adopted as a molecular weight distribution (Mw/Mn). Polystyrene was used as a standard sample, and the polystyrene-equivalent molecular weight was measured. The measurement of polystyrene-equivalent molecular weight by GPC was performed under the following measurement conditions.
a) Measurement instrument: HPLC LC-2000Plus series manufactured by JASCO Corporation
b) Column: Two Shodex KF-804L columns
c) Oven temperature: 40° C.
d) Eluent: Toluene 0.7 mL/min
e) Standard sample: Polystyrene
f) Injection volume: 20 μL
g) Concentration: 0.05 g/10 mL
h) Sample preparation: The sample was dissolved by stirring at room temperature using toluene as the solvent.

### <Evaluation Sample>

### 1. Component (A)

As the component (A), a compound (A-1) and a compound (A-2) represented by Formula (1-1), a compound (A-3) represented by Formula (1-2), and a compound (A-4) represented by Formula (1-3) were used.

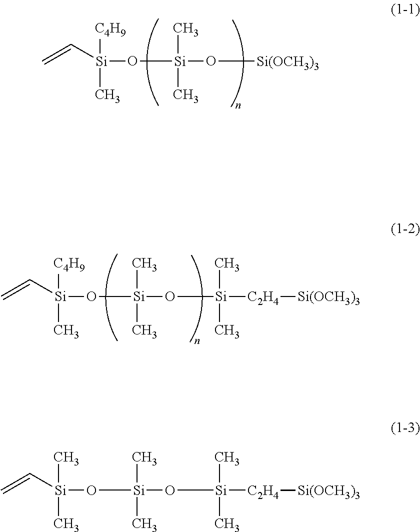

(In Formulas (1-1), (1-2), and (1-3), n is an integer arbitrarily selected to achieve the number average molecular weight shown in Table 1)

### 2. Comparative Component

As the comparative component, a compound (C-1) and a compound (C-2) represented by Formula (1-1) above, and a compound (C-3) represented by the following Formula (2) were used. The compounds (C-1) and (C-2) were prepared to have Mw/Mn greater than 1.30, and the compound (C-3) was prepared to have Mw/Mn of 1.30 or less.

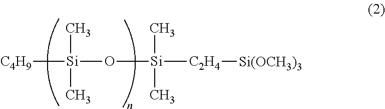

(In Formula (2), n is an integer arbitrarily selected to achieve the number average molecular weight shown in Table 1)

The molecular weight distributions, etc., of the compounds (A-1), (A-2), (A-3), (A-4), (C-1), (C-2), and (C-3) are summarized in Table 1.

TABLE 1

| | Mn | Mw | Mw/Mn |
|---|---|---|---|
| A-1 (Example 1, Example 3) | 3,790 | 4,500 | 1.19 |
| A-2 (Example 2) | 4,240 | 4,780 | 1.13 |
| A-3 (Example 4) | 3,610 | 4,250 | 1.18 |
| A-4 (Example 5) | 3,260 | 3,850 | 1.18 |
| C-1 (Comparative Example 1) | 3,720 | 5,340 | 1.44 |
| C-2 (Comparative Example 2) | 4,060 | 8,010 | 1.98 |
| C-2 (Comparative Examples 3, 5) | 3,000 | 3,270 | 1.09 |

### Example 1

As the component (A), polydimethylsiloxane (A-1) shown in Table 1, as the component (B), spherical alumina with an average diameter of 4 μm (DAW-03 manufactured by Denka Co., Ltd.) (B-1) and spherical alumina with an average diameter of 43 μm (DAW-45 manufactured by Denka Co., Ltd.) (B-2), as the component (C), vinyl-containing dimethylpolysiloxane represented by Formula (3) (a vinyl group content of 0.2 mmol/g) (C-4) were mixed according to the component ratios shown in Table 2. The mixture was then stirred by using a spatula, followed by kneading using AWATORI RENTARO Vacuum Type (Model: ARV-310) of THINKY CORPORATION at 1000 rpm for 2 minutes under atmospheric pressure conditions and at 1000 rpm for 1 minute under a reduced pressure condition. After kneading, as the component (D), tetrakis(dimethylsiloxy)silane (D-1) and Karstedt's catalyst (D-2), and as the component (E), 1,3,5,7-tetramethyl-1,3,5,7-tetravinylcyclotetrasiloxane were added according to the component ratios shown in Table 2. The mixture was then stirred by using a spatula, followed by kneading using AWATORI RENTARO Vacuum Type (Model: ARV-310) of THINKY CORPORATION at 1000 rpm for 2 minutes under an atmospheric pressure condition and at 1000 rpm for 1 minute a under reduced pressure condition to prepare the composition for evaluation. A mixed liquid prepared to have a weight ratio of 1:9 was used for the Karstedt's catalyst and 1,3,5,7-tetramethyl-1,3,5,7-tetravinylcyclotetrasiloxane. In Table 2, the values for the respective components are the number of parts when component (B) is 100 parts by weight.

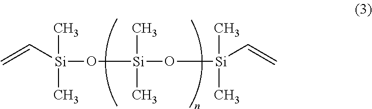

### <Flowability Evaluation>

The flowability of the composition prepared as described above was evaluated by measuring the shear viscosity using a rheometer (MCR302 manufactured by Anton Paar) under the following conditions.
a) Plate shape: Circular plate 25 mm φ
b) Sample thickness: 1 mm
c) Temperature: 25±1° C.
d) Shear rate: 10s⁻¹

### <Oil Bleed Evaluation>

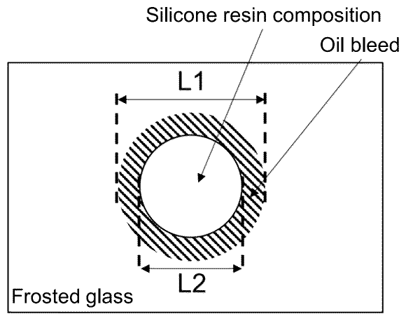

0.6 g of the composition prepared as described above was coated to a frosted glass plate and sandwiched with another glass plate to form a thickness of 1 mm. After heat curing at 180° C. for 3 hours, the length of the oil bleed that seeped out around the composition was measured, and the ratio to the width of the composition was calculated to evaluate the oil bleed. Specifically, the bleed length ratio was calculated by using lengths L1 and L2 in FIG. 1 according to Equation (4). A smaller ratio indicates a higher inhibitory effect on oil bleed.

$$( Bleed length ratio ) = ( L 1 - L 2 ) / L 2 \qquad ( 4 )$$

### Example 2

A composition was prepared in the same manner as in Example 1, except that (A-1) in Example 1 was changed to (A-2), and flowability evaluation and oil bleed evaluation were performed on the composition.

### Example 3

A composition was prepared in the same manner as in Example 1, except that the component ratio of each component in Example 1 was changed to that shown in Table 3. Flowability evaluation and oil bleed evaluation were performed on the composition.

### Example 4

A composition was prepared in the same manner as in Example 3, except that (A-1) in Example 3 was changed to (A-3), and flowability evaluation and oil bleed evaluation were performed on the composition.

### Example 5

A composition was prepared in the same manner as in Example 3, except that (A-1) in Example 3 was changed to (A-4), and flowability evaluation and oil bleed evaluation were performed on the composition.

### Comparative Examples 1 to 3

A composition was prepared in the same manner as in Example 1, except that (A-1) in Example 1 was changed to (A-3). Flowability evaluation and oil bleed evaluation were performed on the compositions.

### Comparative Example 4

A composition was prepared in the same manner as in Example 1, except that (A-1) in Example 1 was absent, and flowability evaluation and oil bleed evaluation were performed on the composition.

The components of the Examples and Comparative Examples, as well as the results of the flowability evaluation and oil bleed evaluation, are summarized in Table 2 and Table 3.

TABLE 2

| | | Example | | Comparative Example | | | |
|---|---|---|---|---|---|---|---|
| | | 1 | 2 | 1 | 2 | 3 | 4 |
| Component | A-1 | 1 | | | | | |
| (A) | A-2 | | 1 | | | | |
| Component | B-1 | 40 | 40 | 40 | 40 | 40 | 40 |
| (B)* | B-2 | 60 | 60 | 60 | 60 | 60 | 60 |
| Component | C-1 | | | 1 | | | |
| (C) | C-2 | | | | 1 | | |
| | C-3 | | | | | 1 | |
| | C-4 | 12.6 | 12.6 | 12.6 | 12.6 | 12.6 | 13.7 |
| Component | D-1 | 0.2 | 0.2 | 0.2 | 0.2 | 0.2 | 0.2 |
| (D) | D-2 | 0.001 | 0.001 | 0.001 | 0.001 | 0.001 | 0.001 |

| | | | | | | |
|---|---|---|---|---|---|---|
| Component (E) | 0.01 | 0.01 | 0.01 | 0.01 | 0.01 | 0.01 |
| Shear viscosity | 12 | 13 | 14 | 20 | 13 | 24 |
| (Pa · s) | | | | | | |
| Bleed length ratio | 0.26 | 0.20 | 0.29 | 0.24 | 0.32 | 0.23 |

*the content of the component (B) is 65 volume % based on the volume of the silicone resin composition

TABLE 3

| | | | | | Comparative | |
|---|---|---|---|---|---|---|
| | | Example | | | Example | |
| | | 3 | 4 | 5 | 4 | 5 |
| Component | A-1 | 3 | | | | |
| (A) | A-3 | | 3 | | | |
| | A-4 | | | 3 | | |
| Component | B-1 | 40 | 40 | 40 | 40 | 40 |
| (B)* | B-2 | 60 | 60 | 60 | 60 | 60 |
| Component | C-1 | | | | | |
| (C) | C-2 | | | | | |
| | C-3 | | | | | 3 |
| | C-4 | 10.6 | 10.6 | 10.6 | 13.7 | 10.7 |
| Component | D-1 | 0.3 | 0.3 | 0.3 | 0.2 | 0.2 |
| (D) | D-2 | 0.001 | 0.001 | 0.001 | 0.001 | 0.001 |

| | | | | | |
|---|---|---|---|---|---|
| Component (E) | 0.01 | 0.01 | 0.01 | 0.01 | 0.01 |
| Shear viscosity | 8 | 10 | 9 | 24 | 7 |
| (Pa · s) | | | | | |
| Bleed length ratio | 0.23 | 0.17 | 0.07 | 0.25 | 0.33 |

*the content of the component (B) is 65 volume % based on the volume of the silicone resin composition

In the comparison of different molecular weight distributions, it was found that the compositions added with the component (A) (Examples 1 and 2) showed similar shear viscosity and higher oil bleed inhibitory effect than Comparative Example 1, while showing similar oil bleed inhibitory effect and lower shear viscosity than Comparative Example 2. In the comparison of different polydimethylsiloxanes, it was found that the compositions added with the component (A) (Examples 1 and 2) showed equal or lower shear viscosity and higher oil bleed inhibitory effect than Comparative Example 3. In the comparison of the presence or absence of the component (A), it was found that the compositions added with the component (A) (Examples 1 and 2) showed a similar oil bleed inhibitory effect and a lower shear viscosity than Comparative Example 4.

It was found that the composition (Example 3) in which a higher amount of the component (A) was added than Example 1 showed a lower shear viscosity than Comparative Example 4. The compositions (Examples 4 and 5) in which the component (A-3) or (A-4) was added were found to have lower shear viscosity than Comparative Example 4. The compositions (Examples 3, 4, and 5) in which the component (A) was added showed a higher oil bleed inhibitory effect than Comparative Examples 4 and 5.

Accordingly, it was found that the composition added with polydimethylsiloxane represented by Formula (1) with a molecular weight distribution of 1.30 or less can achieve both shear viscosity and oil bleed inhibitory effect.

### Example 6

A composition was prepared by using the same method as in Example 1, and evaluations of heat-resistant mass reduction rate and tensile test were performed.

### <Evaluation of Heat-Resistant Mass Reduction Rate>

Two glass plates were sandwiched with a Naflon SP packing (4 mm diameter) manufactured by Nichias Corporation as a spacer. The composition prepared as described above was poured therein and cured by heating at 150° C. for 3 hours to obtain a cured product with a smooth surface and a thickness of 4 mm after removing the glass plates. The cured product was each stored in a convection drying oven under atmospheric conditions at 150° C. for 1,000 hours. The mass (weight) was measured by using an electronic balance [manufactured by Mettler Toledo], and the rate of change in mass (weight) reduction (mass (weight) reduction rate) [[mass (weight) change rate (%)=(initial mass (weight)−mass (weight) after 1,000 hours)/initial mass (weight)]×100] relative to the original mass (weight) was measured.

### <Evaluation of Tensile Test>

The composition was applied and formed into a film on a glass substrate by using an applicator. The composition was heated and dried at 150° C. for 3 hours, and then peeled off from the glass substrate to prepare a thin film. For the obtained cured product, a tensile test was performed at room temperature by using a No. 8 dumbbell test piece at a tensile speed of 5 mm/min, and the elongation (elongation at break) and stress (breaking stress) were measured.

### Example 7

A composition was prepared by using the same method as in Example 6, except that (A-1) in Example 6 was changed to (A-3), and evaluations of heat-resistant mass reduction rate and tensile test were performed.

### Comparative Example 6

A composition was prepared by using the same method as in Example 6, except that (A-1) in Example 6 was changed to (C-3), and evaluations of heat-resistant mass reduction rate and tensile test were performed.

### Comparative Example 7

A composition was prepared by using the same method as in Example 6, except that (A-1) in Example 6 was absent, and evaluations of heat-resistant mass reduction rate and tensile test were performed.

TABLE 4

| | | Example | | Comparative Example | |
|---|---|---|---|---|---|
| | | 6 | 7 | 6 | 7 |
| Component (A) | A-1 | 1 | | | |
| | A-3 | | 1 | | |
| Component (B)* | B-1 | 40 | 40 | 40 | 40 |
| | B-2 | 60 | 60 | 60 | 60 |
| | C-3 | | | 1 | |
| | C-4 | 12.6 | 12.6 | 12.6 | 13.7 |
| Component (D) | D-1 | 0.2 | 0.2 | 0.2 | 0.2 |
| | D-2 | 0.001 | 0.001 | 0.001 | 0.001 |

| | | | | |
|---|---|---|---|---|
| Component (E) | 0.01 | 0.01 | 0.01 | 0.01 |
| Mass reduction rate [%] | 0.24 | 0.24 | 0.41 | 0.32 |
| after 1000-hour storage | | | | |
| at 150° C. | | | | |
| Elongation (%) | 39.11 | 24.95 | 17.32 | 23.48 |
| Breaking stress [N/mm²] | 2.03 | 2.23 | 0.16 | 1.09 |

*the content of the component (B) is 65 volume % based on the volume of the silicone resin composition

In the evaluation of heat-resistant mass reduction rate, it was found that the compositions added with the component (A) (Examples 6 and 7) exhibited smaller mass reduction rates than Comparative Examples 6 and 7.

Accordingly, it was found that the composition added with polydimethylsiloxane represented by Formula (1) with a molecular weight distribution of 1.30 or less can be utilized because of excellent heat resistance even in an environment with a high heat generation amount associated with a higher level of integration and a higher output of circuit boards.

In the evaluation of the tensile test, it was found that the compositions (Examples 6 and 7) added with the component (A) exhibited larger elongation (elongation at break) and stress (breaking stress), respectively than Comparative Examples 6 and 7.

Accordingly, it was found that the compositions added with polydimethylsiloxane represented by Formula (1) with a molecular weight distribution of 1.30 or less can be utilized because such compositions exhibit larger elongation and breaking stress, enabling them to conform to other materials. As a result, these compositions can be used as an intervening material between an electronic component and a cooling member inside an electronic device.

From the above, it can be concluded that the silicone resin composition of the invention excels in workability and exhibits superior performance in inhibiting oil bleed during use.

### INDUSTRIAL APPLICABILITY

The silicone resin composition of the invention can be utilized as a thermally conductive material to be interposed between a heat-generating electronic component such as a transistor, an IC chip, and a memory element, and a cooling member such as a heat sink.

1. A silicone resin composition, comprising: as a component (A), an organopolysiloxane that is represented by Formula (1) and has a molecular weight distribution, which is defined as Mw/Mn, of not more than 1.30, 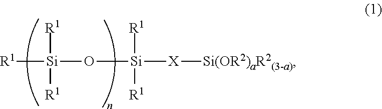
wherein, in Formula (1), each R¹ independently represents a monovalent saturated hydrocarbon group or a monovalent aromatic hydrocarbon group, each R² independently represents a monovalent saturated hydrocarbon group, X represents oxygen or a divalent hydrocarbon group, n is an integer equal to or greater than 1, and a is an integer from 1 to 3; and
a thermally conductive filler, as a component (B).

2. The silicone resin composition as claimed in claim 1, further comprising, as a component (C), an organopolysiloxane other than the component (A).

3. The silicone resin composition as claimed in claim 2, further comprising, as a component (D), a cross-linking agent.

4. The silicone resin composition as claimed in claim 1, wherein a content of the component (B) is 50 vol % or more based on a volume of the silicone resin composition.

5. A thermally conductive sheet, formed by curing the silicone resin composition as claimed in claim 3.

6. An organopolysiloxane represented by Formula (1) and has a molecular weight distribution, which is defined as Mw/Mn, of not more than 1.30, 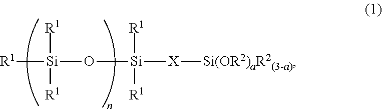
wherein in Formula (1), each R¹ independently represents a monovalent saturated hydrocarbon group or a monovalent aromatic hydrocarbon group, each R² independently represents a monovalent saturated hydrocarbon group, X represents oxygen or a divalent hydrocarbon group, n is an integer equal to or greater than 1, and a is an integer from 1 to 3.

7. A thermally conductive sheet, formed by curing the silicone resin composition as claimed in claim 4.
